(19) United States
(12) Patent Application Publication
(10) Pub. No.: US 2019/0239662 A1
(43) Pub. Date: Aug. 8, 2019

(54) FILM HAVING A LIGHT-REFLECTIVE SURFACE FOR TOILET LID

(71) Applicant: Clayton Ronnie COLE, Sutton West (CA)

(72) Inventor: Clayton Ronnie COLE, Sutton West (CA)

(21) Appl. No.: 15/889,348

(22) Filed: Feb. 6, 2018

(51) Int. Cl. A47G 1/16; A47K 13/24; G09B 19/00; A47G 1/02; A47G 1/17; A45D 42/24

(52) U.S. Cl. CPC A47G 1/1653; A47K 13/24; A45D 42/24; A47G 1/02; A47G 1/17; G09B 19/0076

(57) ABSTRACT

An apparatus includes a flexible film configured to be applied to a toilet. The flexible film has a light-reflective surface.

### TECHNICAL FIELD

This document relates to the technical field of (and is not limited to) an apparatus including a flexible film configured to be applied to a toilet (such as, to a lid of the toilet), in which the flexible film has a light-reflective surface, and/or an apparatus including a toilet in combination with a flexible film configured to be applied to the toilet (in which the flexible film has a light-reflective surface), and/or a method therefor.

### BACKGROUND

A toilet is a piece of hardware configured for the collection (and/or disposal) of human urine and feces. Toilets may be with or without flushing water (that is, a flush toilet or a dry toilet). Some types of flush toilets are configured to be connectable to a sewer system in urban areas and/or to septic tanks in less built-up areas. Some types of dry toilets are configured to be connected to a pit, a removable container, a composting chamber and/or other storage device, a treatment device, any other kind and any equivalent thereof. Toilets are commonly made of ceramic (porcelain), concrete, plastic or wood.

### SUMMARY

It will be appreciated that there exists a need to mitigate (at least in part) at least one problem associated with the existing toilets (also called the existing technology). After much study of the known systems and methods with experimentation, an understanding (at least in part) of the problem and its solution has been identified (at least in part) and is articulated (at least in part) as follows:

The known toilet may not be convenient for use by an untrained user (such as, a child, etc.). For instance, the child may be unable to teach themselves and/or to be self-sufficient with confidence once they have cleaned themselves at the toilet (such as, when needed for cleaning up after completing natural bodily functions). For instance, a child may not be able to check their own state of cleanliness in these situations, which may call for continued dependence or reliance on a parent for assistance. It would be desirable, for these given situations, for the user to become more self-reliant in these matters by using a device for such personal assistance.

To mitigate, at least in part, at least one problem associated with the existing technology, there is provided (in accordance with a major aspect) an apparatus.

The apparatus includes and is not limited to (comprises) a flexible film configured to be applied to the toilet. Preferably, the flexible film is configured to be applied to a surface of (associated with) the toilet (such as, an inner lid surface of a movable toilet lid, etc.). A technical effect of the flexible film with the light-reflective surface is that the light-reflective surface may be utilized by the user for self-inspection (such as, when needed for cleaning up after completing natural bodily functions) while the user is positioned proximate to the light-reflective surface of the flexible film (once the flexible film is adhered to an aspect of the toilet, such as to the inner lid surface of the movable toilet lid). Another technical effect of the flexible film with the light-reflective surface is that for the case where the movable toilet lid is inadvertently shut with a hard force, the above arrangement reduces the possibility of breakage of the light-reflective surface of the flexible film and/or reduces the possibility of unwanted injury to the user and/or unwanted replacement of the flexible film.

To mitigate, at least in part, at least one problem associated with the existing technology, there is provided (in accordance with a major aspect) an apparatus.

The apparatus includes and is not limited to (comprises) a flexible film configured to be applied to a surface of (associated with) the toilet. Preferably, the flexible film is configured to be applied to an inner lid surface of a movable toilet lid of a toilet having a bowl (also called a basin, etc.). The movable toilet lid, in use, is movable between an open condition and a closed condition relative to the bowl of the toilet. The flexible film has a light-reflective surface and a planar surface configured to be positioned (and affixed), at least in part, in a close proximate contact relationship (adhering relationship or affixed relationship, etc.) with an inner lid surface of a movable toilet lid. Additional detailed technical features of the flexible film are identified below.

To mitigate, at least in part, at least one problem associated with the existing technology, there is provided (in accordance with a major aspect) an apparatus.

The apparatus includes and is not limited to (comprises) a synergistic combination of a toilet and a flexible film. The flexible film is configured to be applied to a surface of (associated with) the toilet (such as, an inner lid surface of a movable toilet lid, etc.).

To mitigate, at least in part, at least one problem associated with the existing technology, there is provided (in accordance with a major aspect) a method.

The method is for the application of (applying) a flexible film configured to be applied to a surface of (associated with) the toilet. Preferably, the flexible film is configured to be applied to an inner lid surface of a movable toilet lid. The flexible film has a light-reflective surface and a planar surface configured to be positioned (and affixed, adhered, etc.), at least in part, in a close proximate contact relationship with the inner lid surface of the movable toilet lid. The toilet has a bowl and the movable toilet lid is configured to be movable between an open condition and a closed condition relative to the bowl.
The method includes and is not limited to (comprises) selectively detaching a removable protection layer from an adhesive layer. The removable protection layer is removeably (removably) positionable on (and is also selectively detachable from) the adhesive layer. The adhesive layer is positioned on the planar surface of the flexible film.
In accordance with an option, the method further includes and is not limited to (comprises) adhering the planar surface of the flexible film to the inner lid surface of the movable toilet lid once the removable protection layer is selectively detached from the adhesive layer. Preferably, this is done in such a way that the planar surface of the flexible film, in use, is fitted, at least in part, to the inner lid surface of the movable toilet lid upon adherence of the adhesive layer to the inner lid surface of the movable toilet lid.
Preferably, this is also done in such a way that the light-reflective surface, in use, faces away from the inner lid surface of the movable toilet lid.
Preferably, the light-reflective surface, in use, reflects an image of a portion of the user to the user once: (A) the movable toilet lid, in use, is positioned in an upwardly-oriented orientation, and (B) the user is positioned proximate to the light-reflective surface of the planar surface of the flexible film which is adhered to the inner lid surface of the movable toilet lid.
Preferably, the light-reflective surface may be utilized by the user for self-inspection while the user is positioned proximate to the light-reflective surface of the flexible film which is adhered to the inner lid surface of the movable toilet lid.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify key features or essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 and FIG. 2 depict perspective views of embodiments of a flexible film and a toilet; and

FIG. 3 and FIG. 4 depict perspective views of embodiments of the flexible film of FIG. 1; and

FIG. 5 depicts a close-up perspective view of an embodiment of the flexible film of FIG. 1; and

FIG. 6 depicts a close-up front view of embodiments of the flexible film and the toilet of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 flexible film
102 light-reflective surface
104 adhesive layer
106 planar surface
108 removable protection layer
900 movable toilet lid
901 bowl
902 toilet
906 inner lid surface
908 user
910 direction

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the claim is defined by the claims (in which the claims may be amended during patent examination after the filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described. It will be appreciated that the scope of the meaning of a device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless specifically stated otherwise.

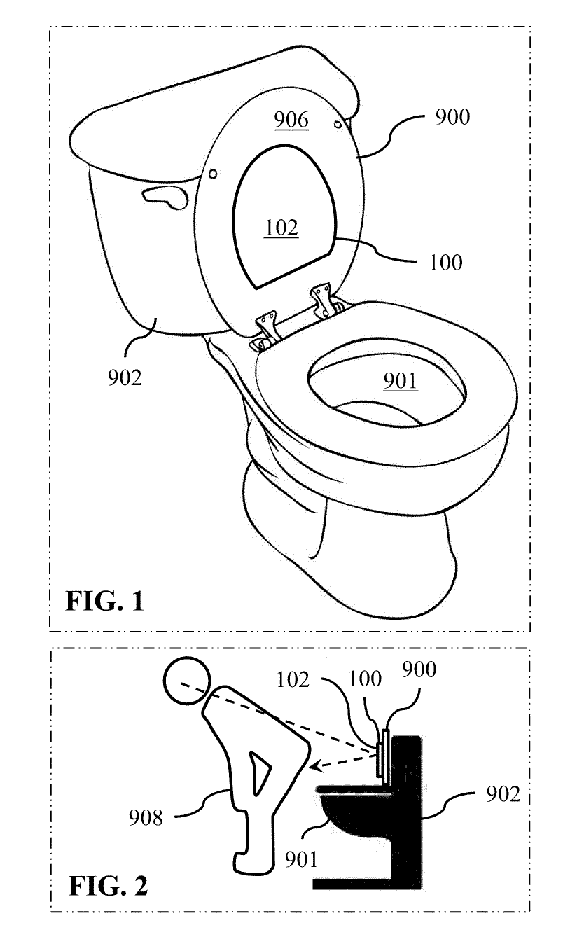

FIG. 1 and FIG. 2 depict perspective views of embodiments of a flexible film 100 and a toilet 902.

In accordance with the embodiments as depicted in FIG. 1 and FIG. 2, the toilet 902 has a bowl 901. The toilet 902 also has a movable toilet lid 900 (that is movable relative to the bowl 901). The movable toilet lid 900 has an inner lid surface 906 configured to be movable between an open condition and a closed condition relative to the bowl 901 of the toilet 902. The movable toilet lid 900 is pivotally movable or pivotally connectable to the inner lid surface 906. In the open condition, the bowl 901 is exposed for utilization by the user 908. In the closed condition, the bowl 901 is not exposed for utilization by the user 908.

The flexible film 100 is configured to be applied to (fixedly attached to) the toilet 902. Preferably, the flexible film 100 is configured to be applied to a surface of (associated with) the toilet 902 (such as, the inner lid surface 906 of the movable toilet lid 900, etc.). Preferably, the flexible film 100 is configured to be positioned relative to (fixedly attached, either directly or indirectly, to an aspect of or a part of) the toilet 902 having the bowl 901. Preferably, the toilet 902 has the movable toilet lid 900 as well. The movable toilet lid 900 has the inner lid surface 906 configured to be movable between the open condition and the closed condition relative to the bowl 901 of the toilet 902. Preferably, the flexible film 100 includes any one (or more of or at least one of) a layer, a sheet, a web, a flexible planar sheet, any other kind, and any equivalent thereof. Preferably, the flexible film 100 is configured to be applied to the inner lid surface 906 of the movable toilet lid 900 of the toilet 902. Preferably, the flexible film 100 has a light-reflective surface 102.

A technical effect of the flexible film 100 with the light-reflective surface 102 is that the light-reflective surface 102 may be utilized by the user 908 for self-inspection (such as, when needed for cleaning up after completing natural bodily functions) while the user 908 is positioned proximate to the light-reflective surface 102 of the flexible film 100 (once the flexible film 100 is adhered to an aspect of the toilet 902, such as to the inner lid surface 906 of the movable toilet lid 900).

Another technical effect of the flexible film 100 with the light-reflective surface 102 is that for the case where the movable toilet lid 900 is inadvertently shut with a hard force, the above arrangement reduces the possibility of breakage of the light-reflective surface 102 of the flexible film 100 and/or reduces the possibility of unwanted injury to the user 908 and/or unwanted replacement of the flexible film 100.

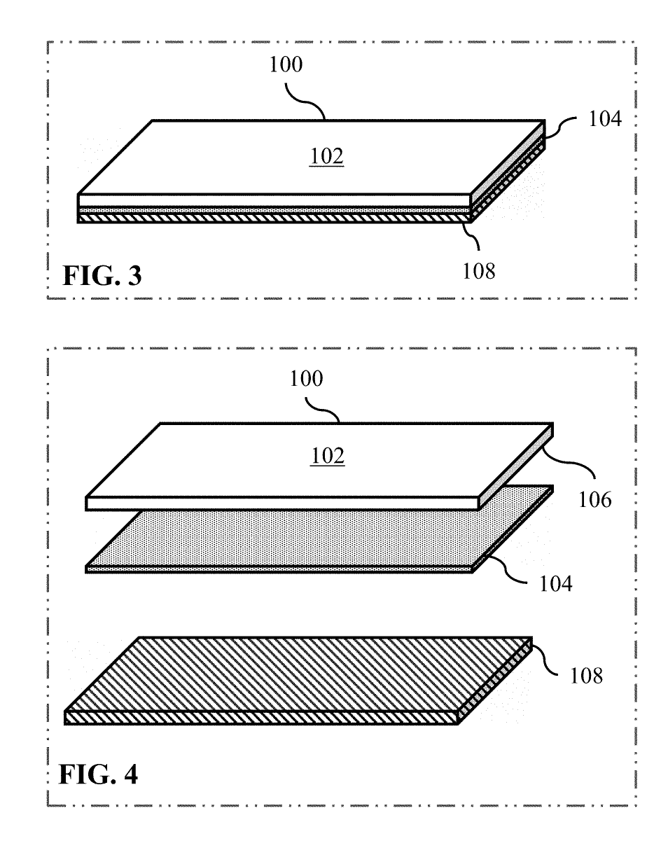

FIG. 3 and FIG. 4 depict perspective views of embodiments of the flexible film 100 of FIG. 1.

In accordance with the embodiments as depicted in FIG. 3 and FIG. 4, the flexible film 100 has the light-reflective surface 102 (configured to reflect light in a manner similar to a mirror). The light-reflective surface 102 may be curved or flat once installed.

Preferably, the flexible film 100 also has a planar surface 106 configured to be positioned and affixed (connected or adhered), at least in part, in a close proximate contact relationship with an aspect of the toilet 902 (such as, the inner lid surface 906 of the movable toilet lid 900, as depicted in the embodiments of FIG. 1 and/or FIG. 2). Preferably, the planar surface 106 faces away from the light-reflective surface 102. The planar surface 106 is configured to be positionable proximate to an aspect of the toilet 902 (such as, the inner lid surface 906 of the movable toilet lid 900, as depicted in the embodiments of FIG. 1 and/or FIG. 2). Preferably, the planar surface 106 is configured to be positioned and affixed (adhered), at least in part, in a close proximate contact relationship with an aspect of the toilet 902 (such as, the inner lid surface 906 of the movable toilet lid 900, as depicted in the embodiments of FIG. 1 and/or FIG. 2). Preferably, the planar surface 106 extends along a planar side of the flexible film 100. The planar surface 106 is configured to be positioned to face the inner lid surface 906 of the movable toilet lid 900 once the flexible film 100, in use, is positioned in a flattened relationship (condition, orientation) with an aspect of the toilet 902 (such as, with the inner lid surface 906 of the movable toilet lid 900, as depicted in the embodiments of FIG. 1 and/or FIG. 2).

Preferably, the flexible film 100 also has an adhesive layer 104 extending from the planar surface 106. The adhesive layer 104 is configured to contactably adhere, at least in part, the planar surface 106 of the flexible film 100 and an aspect of the toilet 902 (such as, the inner lid surface 906 of the movable toilet lid 900, as depicted in the embodiments of FIG. 1 and/or FIG. 2) with each other. This arrangement may be done once the flexible film 100, in use, is positioned in a flattened relationship with an aspect of the toilet 902 (such as, the inner lid surface 906 of the movable toilet lid 900) so that upon application of a pressure to the flexible film 100, the adhesive layer 104, in use, contactably adheres, at least in part, the planar surface 106 with the inner lid surface 906.

Preferably, the adhesive layer 104 is positioned on the planar surface 106 of the flexible film 100. The adhesive layer 104 is configured to adhere (fixedly adhere or removeably adhere, etc.), at least in part, the planar surface 106 of the flexible film 100 to the inner lid surface 906 of the movable toilet lid 900. This is done in such a way that the adhesive layer 104, in use, maintains the flexible film 100, in use, affixed (releasably affixed), at least in part, in a close proximate contact relationship with the inner lid surface 906 of the movable toilet lid 900.

Preferably, the adhesive layer 104 extends from the planar surface 106 of the flexible film 100 in such a way that the adhesive layer 104, in use, adheres, at least in part, the planar surface 106 of the flexible film 100 to the inner lid surface 906 of the movable toilet lid 900. The light-reflective surface 102, in use, faces away from the inner lid surface 906 of the movable toilet lid 900 (as depicted in the embodiments of FIG. 1 or FIG. 2) once the adhesive layer 104, in use, adheres, at least in part, the planar surface 106 to the inner lid surface 906.

Preferably, the adhesive layer 104 is configured to adhere (fixedly adhere), at least in part, the planar surface 106 of the flexible film 100 to the inner lid surface 906 of the movable toilet lid 900 in such a way that the adhesive layer 104, in use, maintains the flexible film 100 affixed, at least in part, in a close proximate contact relationship with the inner lid surface 906 of the movable toilet lid 900.

Preferably, the flexible film 100 also has a removable protection layer 108. The removable protection layer 108 may include a detachable protection film, a detachable protection layer, any other kind, and any equivalent thereof. The removable protection layer 108 is configured to detachably cover, at least in part, the adhesive layer 104. The removable protection layer 108 is also configured to be selectively detachable from the adhesive layer 104. This arrangement is done so that detachment of the removable protection layer 108 from the adhesive layer 104, in use, exposes the adhesive layer 104 for an adhering relationship (as depicted in the embodiments of FIG. 1 and FIG. 2) between the planar surface 106 of the flexible film 100 and any reasonable aspect or portion of the toilet 902 (such as, the inner lid surface 906 of the movable toilet lid 900).

Preferably, the removable protection layer 108 is detachably positionable on, and is also selectively detachable (removable) from the adhesive layer 104. This is done in such a way that (as depicted in the embodiments of FIG. 1 or FIG. 2) the light-reflective surface 102, in use, faces away from the inner lid surface 906 of the movable toilet lid 900 once: (A) the removable protection layer 108, in use, is selectively detached from, the adhesive layer 104, and (B) the adhesive layer 104, in use, is positionable to contact, at least in part, the inner lid surface 906 of the movable toilet lid 900, and (C) the adhesive layer 104, in use, adheres, at least in part, the planar surface 106 of the flexible film 100 to the inner lid surface 906 of the movable toilet lid 900 once the adhesive layer 104, in use, is positioned to contact, at least in part, the inner lid surface 906 of the movable toilet lid 900.

Preferably, the removable protection layer 108 is removeably (removably) positionable on, and is also selectively detachable (removable) from, the adhesive layer 104. This arrangement is done in such a way that removal of the removable protection layer 108, in use, exposes the adhesive layer 104 positioned on the planar surface 106 of the flexible film 100 for subsequent adherence of the planar surface 106 of the flexible film 100 to an aspect or portion of the toilet 902 (such as, the inner lid surface 906 of the movable toilet lid 900, as depicted in the embodiments of FIG. 1 or FIG. 2). The planar surface 106 of the flexible film 100, in use, is fitted, at least in part, to (the contour) of the inner lid surface 906 of the movable toilet lid 900 upon adherence of the adhesive layer 104 to the inner lid surface 906 of the movable toilet lid 900.

The light-reflective surface 102 extends along another planar side of the flexible film 100. The flexible film 100 is configured to face away from an aspect or portion of the toilet 902 (such as, the inner lid surface 906 of the movable toilet lid 900, as depicted in the embodiments of FIG. 1 or FIG. 2) once: (A) the removable protection layer 108, in use, is selectively detached from the adhesive layer 104, and (B) the flexible film 100, in use, is positioned in the flattened relationship with the inner lid surface 906 of the movable toilet lid 900, and (C) the adhesive layer 104, in use, is exposed for adhering the planar surface 106 of the flexible film 100 with the inner lid surface 906 of the movable toilet lid 900. Preferably, the light-reflective surface 102 is configured to face away from the inner lid surface 906 of the movable toilet lid 900 once the adhesive layer 104, in use, adheres, at least in part, the planar surface 106 of the flexible film 100 to the inner lid surface 906 of the movable toilet lid 900.

More preferably, the light-reflective surface 102 is configured to face away from the inner lid surface 906 of the movable toilet lid 900 once the adhesive layer 104, in use, adheres, at least in part, the planar surface 106 of the flexible film 100 to the inner lid surface 906 of the movable toilet lid 900 (as depicted in the embodiments of FIG. 1 or FIG. 2). This arrangement is done in such a way that the light-reflective surface 102, in use, reflects an image of a portion of the user 908 to the user 908 once: (A) the removable protection layer 108, in use, is selectively detached from the adhesive layer 104, and (B) the adhesive layer 104, in use, adheres, at least in part, the planar surface 106 of the flexible film 100 to the inner lid surface 906 of the movable toilet lid 900, and (C) the movable toilet lid 900, in use, is positioned in an upwardly-oriented orientation, and (D) the user 908 is positioned proximate to the light-reflective surface 102 of the planar surface 106 of the flexible film 100 which is adhered to the inner lid surface 906 of the movable toilet lid 900.

As a result, the light-reflective surface 102 may be utilized by the user 908 for self-inspection while the user 908 is positioned proximate to the light-reflective surface 102 of the flexible film 100 which is adhered to the inner lid surface 906 of the movable toilet lid 900.

FIG. 5 depicts a close-up perspective view of an embodiment of the flexible film 100 of FIG. 1.

In accordance with the embodiment as depicted in FIG. 5, the removable protection layer 108 is selectively removed from the adhesive layer 104 by the user 908, to thereby expose the adhesive layer 104. Once the flexible film 100, in use, is positioned in a flattened relationship with the inner lid surface 906 of the movable toilet lid 900, and upon application of a pressure to the flexible film 100, the adhesive layer 104, in use, contactably adheres, at least in part, the planar surface 106 with the inner lid surface 906 (as depicted in the embodiments of FIG. 1 or FIG. 2). The light-reflective surface 102, in use, faces away from the inner lid surface 906 of the movable toilet lid 900 once the adhesive layer 104, in use, adheres, at least in part, the planar surface 106 to the inner lid surface 906 (as depicted in the embodiments of FIG. 1 or FIG. 2).

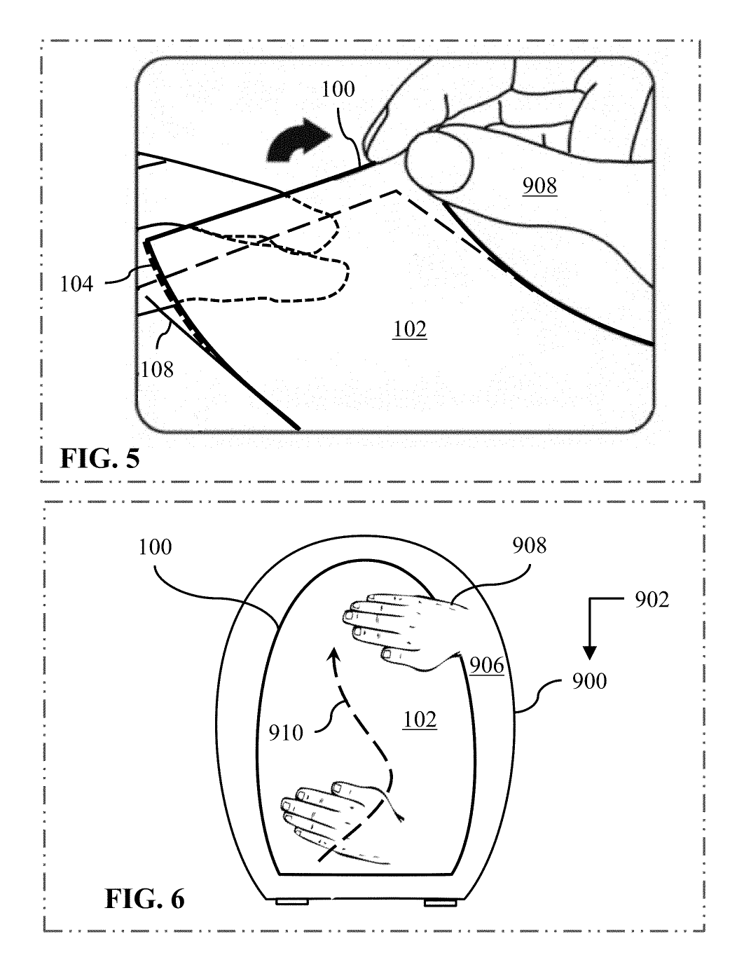

FIG. 6 depicts a close-up front view of embodiments of the flexible film 100 and the toilet 902 of FIG. 1.

In accordance with the embodiment as depicted in FIG. 6, once the removable protection layer 108 has been selectively removed from the adhesive layer 104, the flexible film 100, in use, is positioned in a flattened relationship with the inner lid surface 906 of the movable toilet lid 900. Upon application of a pressure to the flexible film 100 (such as, the user 908 placing a forced smooth wiping action along direction 910). For instance, so that any unwanted air pockets may be removed, etc.), the adhesive layer 104, in use, contactably adheres, at least in part, the planar surface 106 with the inner lid surface 906.

In view of the foregoing, there is provided a method of applying the flexible film 100 to the inner lid surface 906 of a movable toilet lid 900. The flexible film 100 has the light-reflective surface 102 and the planar surface 106 configured to be positioned and affixed, at least in part, in a close proximate contact relationship with the inner lid surface 906 of the movable toilet lid 900.

The method includes selectively detaching the removable protection layer 108 from the adhesive layer 104. The removable protection layer 108 is removeably (removably) positioned on. The removable protection layer 108 is also selectively detachable from the adhesive layer 104 (the adhesive layer 104 is positioned on the planar surface 106 of the flexible film 100).

The method also includes adhering the planar surface 106 of the flexible film 100 to the inner lid surface 906 of the movable toilet lid 900 once the removable protection layer 108 is selectively detached from the adhesive layer 104. This is done in such a way that: (A) the planar surface 106 of the flexible film 100, in use, is fitted, at least in part, to (the contour of) the inner lid surface 906 of the movable toilet lid 900 upon adherence of the adhesive layer 104 to the inner lid surface 906 of the movable toilet lid 900, and (B) the light-reflective surface 102, in use, faces away from the inner lid surface 906 of the movable toilet lid 900. The light-reflective surface 102, in use, reflects an image of a portion of the user 908 to the user 908 once: (A) the movable toilet lid 900, in use, is positioned in an upwardly-oriented orientation, and (B) the user 908 is positioned proximate to the light-reflective surface 102 of the planar surface 106 of the flexible film 100 which is adhered to the inner lid surface 906 of the movable toilet lid 900. The light-reflective surface 102 may be utilized by the user 908 for self-inspection while the user 908 is positioned proximate to the light-reflective surface 102 of the flexible film 100 which is adhered to the inner lid surface 906 of the movable toilet lid 900.

The following is offered as further description of the embodiments, in which any one or more of any technical feature (described in the detailed description, the summary and the claims) may be combinable with any other one or more of any technical feature (described in the detailed description, the summary and the claims). It is understood that each claim in the claims section is an open-ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the invention which does not materially modify the invention. Similarly, unless specifically made clear from its context, numerical values should be construed to include certain tolerances that the person skilled in the art would recognize as having negligible importance as they do not materially change the operability of the invention. It will be appreciated that the description and/or drawings identify and describe embodiments of the apparatus (either explicitly or inherently). The apparatus may include any suitable combination and/or permutation of the technical features as identified in the detailed description, as may be required and/or desired to suit a particular technical purpose and/or technical function. It will be appreciated that, where possible and suitable, any one or more of the technical features of the apparatus may be combined with any other one or more of the technical features of the apparatus (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options would be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the invention. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a flexible film being configured to be applied to a toilet; and
the flexible film having a light-reflective surface.

2. The apparatus of claim 1, wherein:
the flexible film has a planar surface being configured to be positioned and affixed, at least in part, in a close proximate contact relationship with an inner lid surface of a movable toilet lid of the toilet having a bowl, in which the movable toilet lid, in use, is movable between an open condition and a closed condition relative to the bowl of the toilet.

3. The apparatus of claim 2, further comprising:
an adhesive layer positioned on the planar surface of the flexible film.

4. The apparatus of claim 3, wherein:
the adhesive layer is configured to adhere, at least in part, the planar surface of the flexible film to the inner lid surface of the movable toilet lid in such a way that the adhesive layer, in use, maintains the flexible film affixed, at least in part, in a close proximate contact relationship with the inner lid surface of the movable toilet lid.

5. The apparatus of claim 4, further comprising:
a removable protection layer being removeably positioned on, and also being selectively detachable from, the adhesive layer.

6. The apparatus of claim 5, wherein:
the removable protection layer, in use and once removed, exposes the adhesive layer positioned on the planar surface of the flexible film for subsequent adherence of the planar surface of the flexible film to the inner lid surface of the movable toilet lid, in which the planar surface of the flexible film, in use, is fitted, at least in part, to the inner lid surface of the movable toilet lid upon adherence of the adhesive layer to the inner lid surface of the movable toilet lid.

7. The apparatus of claim 6, wherein:
the light-reflective surface is configured to face away from the inner lid surface of the movable toilet lid once the adhesive layer, in use, adheres, at least in part, the planar surface of the flexible film to the inner lid surface of the movable toilet lid.

8. The apparatus of claim 7, wherein:
the light-reflective surface is configured to face away from the inner lid surface of the movable toilet lid once the adhesive layer, in use, adheres, at least in part, the planar surface of the flexible film to the inner lid surface of the movable toilet lid in such a way that the light-reflective surface, in use, reflects an image of a portion of a user to the user.

9. The apparatus of claim 8, wherein:
the light-reflective surface, in use, reflects the image of the portion of the user to the user once:
the removable protection layer, in use, is selectively detached from the adhesive layer; and
the adhesive layer, in use, adheres, at least in part, the planar surface of the flexible film to the inner lid surface of the movable toilet lid; and
the movable toilet lid, in use, is positioned in an upwardly-oriented orientation; and
the user is positioned proximate to the light-reflective surface of the planar surface of the flexible film which is adhered to the inner lid surface of the movable toilet lid; and
whereby the light-reflective surface may be utilized by the user for self-inspection while the user is positioned proximate to the light-reflective surface of the flexible film which is adhered to the inner lid surface of the movable toilet lid.

10. An apparatus, comprising:
a toilet; and
a flexible film having a light-reflective surface and a planar surface configured to be positioned, at least in part, and affixed, at least in part, to the toilet.

11. The apparatus of claim 10, wherein:
the toilet has a bowl and a movable toilet lid having an inner lid surface configured to be movable between an open condition and a closed condition relative to the bowl of the toilet; and
the flexible film is configured to be applied to the inner lid surface of the movable toilet lid.

12. The apparatus of claim 11, wherein:
the planar surface extends along a planar side of the flexible film, and the planar surface being configured to be positioned so that the planar surface, in use, faces the inner lid surface of the movable toilet lid once the flexible film, in use, is positioned in a flattened relationship with the inner lid surface of the movable toilet lid.

13. The apparatus of claim 12, further comprising:
an adhesive layer extending from the planar surface, and the adhesive layer being configured to contactably adhere, at least in part, the planar surface of the flexible film and the inner lid surface of the movable toilet lid with each other once the flexible film, in use, is positioned in the flattened relationship with the inner lid surface of the movable toilet lid so that upon application of a pressure to the flexible film, the adhesive layer, in use, contactably adheres, at least in part, the planar surface with the inner lid surface.

14. The apparatus of claim 13, further comprising:
a removable protection layer being configured to detachably cover, at least in part, the adhesive layer, and to selectively detach, at least in part, from the adhesive layer so that detachment of the removable protection layer from the adhesive layer, in use, exposes the adhesive layer for an adhering relationship between the planar surface of the flexible film and the inner lid surface of the movable toilet lid.

15. The apparatus of claim 14, wherein:
the light-reflective surface extends along another planar side of the flexible film, and the flexible film being configured to face away from the inner lid surface of the movable toilet lid once:
the removable protection layer, in use, is selectively detached from the adhesive layer; and
the flexible film, in use, is positioned in the flattened relationship with the inner lid surface of the movable toilet lid; and
the adhesive layer, in use, is exposed for adhering the planar surface of the flexible film with the inner lid surface of the movable toilet lid.

16. The apparatus of claim 15, wherein:
the light-reflective surface is configured to reflect an image of a portion of a user to the user once:
the removable protection layer, in use, is selectively detached from the adhesive layer; and
the adhesive layer, in use, adheres, at least in part, the planar surface of the flexible film to the inner lid surface of the movable toilet lid; and
the movable toilet lid, in use, is positioned in an upwardly-oriented orientation; and
the user is positioned proximate to the light-reflective surface of the planar surface of the flexible film which is adhered to the inner lid surface of the movable toilet lid; and
whereby the light-reflective surface may be utilized by the user for self-inspection while the user is positioned proximate to the light-reflective surface of the flexible film which is adhered to the inner lid surface of the movable toilet lid.

17. The apparatus of claim 14, wherein:
the light-reflective surface extends along another planar side of the flexible film, and the flexible film being configured to face away from the inner lid surface of the movable toilet lid once:
the removable protection layer, in use, is selectively detached from the adhesive layer; and
the flexible film, in use, is positioned in the flattened relationship with the inner lid surface of the movable toilet lid; and
the adhesive layer, in use, is exposed for adhering the planar surface of the flexible film with the inner lid surface of the movable toilet lid; and
the light-reflective surface is configured to face away from the inner lid surface of the movable toilet lid so that the light-reflective surface, in use, reflects an image of a portion of a user to the user once the adhesive layer, in use, adheres the planar surface of the flexible film with the inner lid surface of the movable toilet lid; and
whereby the light-reflective surface may be utilized by the user for self-inspection while the user is positioned proximate to the light-reflective surface of the flexible film.

18. A method of applying a flexible film to an inner lid surface of a movable toilet lid, in which the flexible film has a light-reflective surface and a planar surface configured to be positioned and affixed, at least in part, in a close proximate contact relationship with the inner lid surface of the movable toilet lid, and in which a toilet has a bowl and the movable toilet lid is configured to be movable between an open condition and a closed condition relative to the bowl, and the method comprising:
selectively detaching a removable protection layer from an adhesive layer, in which the removable protection layer is removeably positioned on the adhesive layer, and in which the removable protection layer is also selectively detachable from the adhesive layer, and in which the adhesive layer is positioned on the planar surface of the flexible film.

19. The method of claim 18, further comprising:
adhering the planar surface of the flexible film to the inner lid surface of the movable toilet lid once the removable protection layer is selectively detached from the adhesive layer in such a way that:
the planar surface of the flexible film, in use, is fitted, at least in part, to the inner lid surface of the movable toilet lid upon adherence of the adhesive layer to the inner lid surface of the movable toilet lid; and
the light-reflective surface, in use, faces away from the inner lid surface of the movable toilet lid.

20. The method of claim 19, wherein:
the light-reflective surface, in use, reflects an image of a portion of a user to the user once:
the movable toilet lid, in use, is positioned in an upwardly-oriented orientation; and
the user is positioned proximate to the light-reflective surface of the planar surface of the flexible film which is adhered to the inner lid surface of the movable toilet lid; and
whereby the light-reflective surface may be utilized by the user for self-inspection while the user is positioned proximate to the light-reflective surface of the flexible film which is adhered to the inner lid surface of the movable toilet lid.
